(19) United States
(12) Patent Application Publication
(10) Pub. No.: US 2016/0024800 A1
(43) Pub. Date: Jan. 28, 2016

(54) BRACKET FOR USE IN CONSTRUCTION OF A BALUSTRADE

(71) Applicant: Maury GRATRIX, Ponoka (CA)

(72) Inventor: Maury GRATRIX, Ponoka (CA)

(21) Appl. No.: 14/630,821

(22) Filed: Feb. 25, 2015

(30) Foreign Application Priority Data
Jul. 23, 2014 (CA) 2857824

(51) Int. Cl. E04F 11/18; F16B 9/02

(52) U.S. Cl. CPC E04F 11/1817; F16B 9/026; E04F 11/1836; E04F 2011/1821

(57) ABSTRACT

A bracket for constructing a balustrade includes a receiving member configured to receive and secure a post therein; and a pivoting member pivotally mounted to the receiving member and configured to be attached to a top plate of a wall to orient the post within the top plate at a desired position, angle, or both. A method of stabilizing a balustrade involves use of the bracket.

### FIELD OF THE INVENTION

The present invention relates generally to a bracket for use in construction of a balustrade, and a method of stabilizing a balustrade using the bracket.

### BACKGROUND OF THE INVENTION

During home or building construction, a balustrade is usually provided along stair treads, landings, balconies, decks, and the like, and generally includes a railing and vertical newel posts which are secured to the railing and are anchored to flooring structures. Since newel posts are pulled and pushed during use, they can become loose and must be properly installed and secured.

Installation of newel posts is time-consuming and costly because special skills, tools, and additional finishing work are required. Newel posts are typically fastened to a floor by installation in a hole cut through the floor. However, it is often challenging to position and place the newel posts properly, requiring a carpenter to rely upon studs and floor joists.

Use of various fastening systems incorporate plates, braces and screws. These systems offer some improvement in installation time, but are overly complicated and suffer from various other limitations. Externally mounted brackets to anchor the posts are available, but provide minimal stability and are surface-mounted, rendering them visually unappealing. Accordingly, there is a need in the art for a way of installing newel posts which mitigates these problems.

### SUMMARY OF THE INVENTION

The present invention relates to a bracket for use in construction of a balustrade, and a method of stabilizing a balustrade using the bracket.

In one aspect, the invention comprises a bracket for constructing a balustrade comprising:
a receiving member configured to receive and secure a post therein; and
a pivoting member pivotally mounted to the receiving member and configured to be attached to a top plate of a wall to orient the secured post within the top plate at a desired position, angle, or both.

In one embodiment, the receiving member and pivoting member are substantially aligned to define an opening extending therethrough for receiving the post. In one embodiment, the receiving member comprises a front wall, a rear wall, a first side wall, a second side wall, an open first end, and an open second end. In one embodiment, the front wall is sized lower vertically than the rear wall, the first side wall, and the second side wall. In one embodiment, the first side wall and the second side wall are sized the same height vertically as the rear wall, and have top cut-away corners complementary to the vertical height of the front wall. In one embodiment, one or more of the front wall, rear wall, first side wall, and second side wall define one or more apertures to allow attachment means to extend therethrough to secure the post to the receiving member.

In one embodiment, the pivoting member comprises a pair of arms, a first mounting plate, and a second mounting plate, wherein the arms, the first mounting plate, and the second mounting plate define a gap sized to receive and accommodate the receiving member. In one embodiment, the gap extends past the front wall and the rear wall.

In one embodiment, the arms are oriented opposed and parallel to each other, are connected at their ends to the first and second mounting plates, and have a bottom cut-away corner at each end. In one embodiment, the arms protrude past the edges of the first and second side walls.

In one embodiment, the arms define opposed throughholes which align with corresponding bores of the first and second side walls to allow attachment means to extend therethrough to pivotally mount the pivoting member to the receiving member. In one embodiment, the throughholes and the bores are positioned along top edges of the first and second side walls. In one embodiment, the first and second side walls define opposed curved slots positioned below the bores. In one embodiment, the arms define opposed openings positioned at the bottom edge of the arms. In one embodiment, a stopper projects outwardly from either the first side wall, the second side wall, or the rear wall.

In one embodiment, the first and second mounting plates define one or more apertures, one or more elongate slots, or both to allow attachment means to extend therethrough to secure the first and second mounting plates onto the top plate. In one embodiment, the front wall defines one or more slots corresponding to the one or more elongate slots of the first mounting plate.

In one embodiment, the first mounting plate defines a window, and the front wall defines a window corresponding to the first mounting plate window, the windows being sized to receive a leg bolt therethrough.

In one embodiment, the pivoting member is pivotable between an angle of about 45° to about 90° relative to the receiving member.

In another aspect, the invention comprises a method of stabilizing a balustrade comprising the steps of:
a) forming a gap within the top plate of the wall for installing the above bracket;
b) sliding the bracket into position within the gap;
c) fastening the bracket onto the top plate;
d) preparing the post to fit into the bracket; and
e) inserting and attaching the post within the bracket at a desired position, angle, or both.

In one embodiment, the method further comprises forming notches on the top plate, the notches being complementary to first and second mounting plates of the pivoting member, and fastening the first and second mounting plates to the notches.

In one embodiment, the method further comprises forming angled edges within the top plate, the edges being complementary to cut-away corners of arms of the pivoting member.

In one embodiment, the method further comprises drilling a leg bolt through the top plate to extend through a mounting plate window, the top plate, a front wall window, and the post.

In one embodiment, the pivoting member is pivoted between an angle of about 45° to about 90° relative to the receiving member.

Additional aspects and advantages of the present invention will be apparent in view of the description, which follows. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawings. In the drawings:

FIG. 1 shows a portion of a typical staircase within a home.

FIG. 2 show a portion of the staircase of FIG. 1.

FIG. 3 is a side view of one embodiment of the bracket shown attached within a wall in an actuating position, wherein the pivoting member of the bracket is angled relative to the receiving member.

FIG. 4 is a front view of one embodiment of the bracket removed from a wall.

FIG. 5 is a rear view of the bracket shown in FIG. 4.

FIG. 6 is a left side view of the bracket shown in FIG. 4.

FIG. 7 is a right side view of the bracket shown in FIG. 4.

FIG. 8 is a top view of one embodiment of the bracket, wherein the bracket is in a resting position with the pivoting member being positioned substantially horizontal relative to the receiving member.

FIG. 9 is a top view of the bracket shown in FIG. 8, wherein the bracket is in an actuating position with the pivoting member being tilted or positioned at an angle towards the front wall.

FIG. 10 is an enlarged top view of a portion of the bracket shown in FIG. 9.

FIG. 11 is a left side view of the bracket shown in FIG. 8, wherein the bracket is in an actuating position with the pivoting member being tilted or positioned at an angle towards the front wall.

FIG. 12 is a right side view of the bracket shown in FIG. 8, wherein the bracket is in an actuating position with the pivoting member being tilted or positioned at an angle towards the front wall.

FIG. 13 is a left side view of the bracket shown in FIG. 8, wherein the bracket is in an actuating position with the pivoting member being tilted or positioned at a 45° angle towards the front wall.

FIG. 14A is a front view of one embodiment of the bracket removed from a wall.

FIG. 14B is a rear view of the bracket shown in FIG. 14A.

FIG. 14C is a left side view of the bracket shown in FIG. 14A.

FIG. 14D is a top view of the bracket shown in FIG. 14A, wherein the bracket is in a resting position with the pivoting member being positioned substantially horizontal relative to the receiving member.

FIG. 14E is an enlarged top view of a portion of the bracket shown in FIG. 14D.

FIGS. 15A-N show the steps for installing the bracket and post within a stairway wall.

### DETAILED DESCRIPTION OF PREFERRED EMBODIMENTS

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

The present invention relates to a bracket for use in construction of a balustrade. The invention also relates to a method of stabilizing a balustrade using the bracket.

As used herein, the term “balustrade” means a rail system including balusters, as featured in staircases, porches, and the like. A rail system is typically a vertical support or barrier erected along exposed edges of floor openings, wall openings, ramps, platforms, and runways to prevent falls of individuals, or within walls.

As used herein, the term “baluster” means an upright vertical bar used to support an upper railing. As used herein, the term “upper railing” means a single bar fixed on top of balusters or supports for various purposes such as, for example, a gripping surface or handhold on a stairway or ramp.

As used herein, the term “post” or “newel post” means a vertical post used to start the balustrade, and used at points of vertical and directional transition.

As used herein, the term “horizontal” means the orientation of a plane or line that is substantially parallel to the plane of the horizon. The term “vertical” means the orientation of a plane or line that is substantially at a right angle to the horizontal plane.

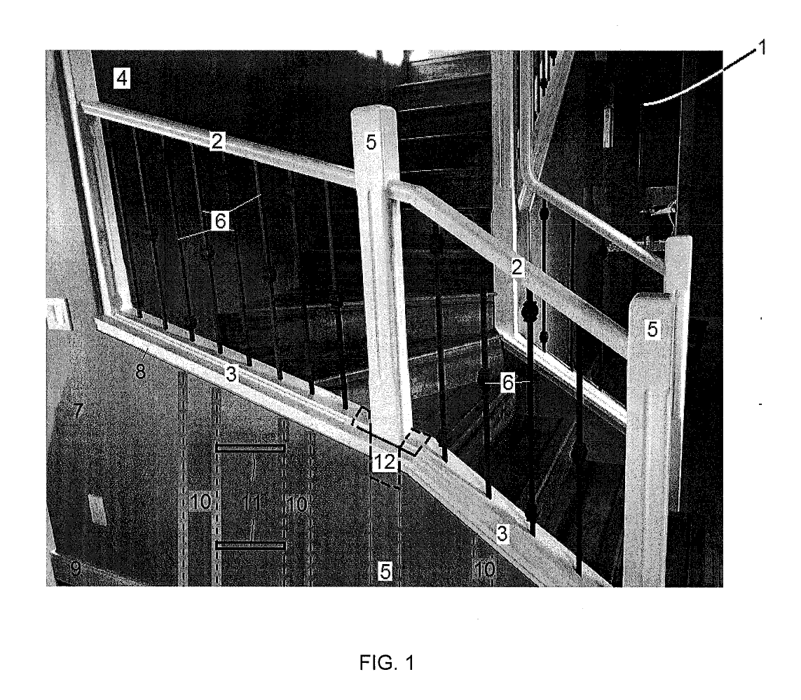

FIG. 1 generally shows a portion of a typical staircase within a home. The staircase has a balustrade (1) including an upper railing (2) and a lower railing (3). Both the upper and lower railings (2, 3) are secured to a side wall (4) at one end and to a newel post (5) at the other end. Multiple newel posts (5) are used at the start, and at points of vertical and directional transition to provide backbone strength to the balustrade (1). Balusters (6) between the upper and lower railings (2, 3) provide safety and support. The underside of the staircase is often hidden or covered by a stairway wall (7). The stairway wall (7) is formed of a top plate (8), a base plate (9), vertical studs or planks of wood (10) between the top plate (8) and base plate (9), and blocking boards (11) between each stud (10) (shown in phantom).

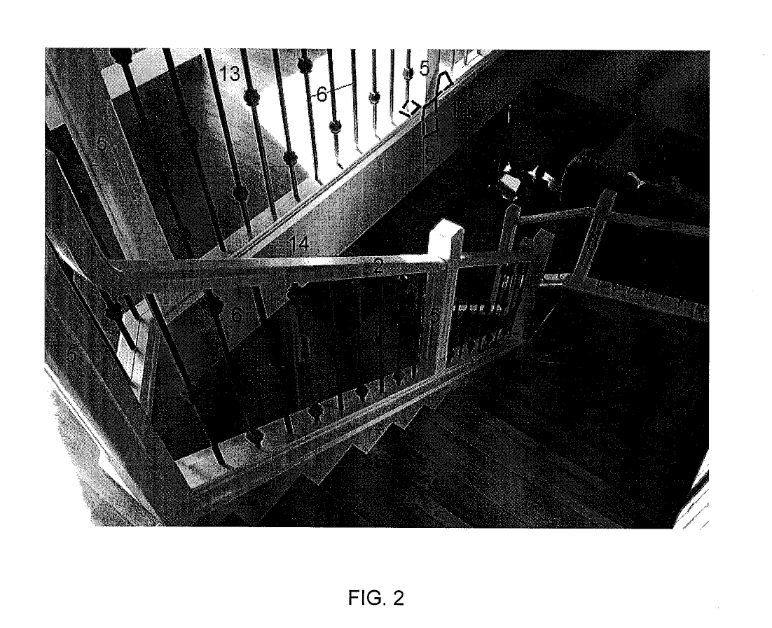

FIG. 2 generally shows another portion of the staircase of FIG. 1, including a landing (13) or floor between flights of stairs, and a ceiling wall (14) which conceals the top plate (8), base plate (9), studs (10), and ceiling joists (not shown).

Newel posts (5) are typically anchored only at their lower ends, but must withstand tremendous lateral forces applied upon the upper railing (2) such that they can become loose and unstable over time. The present invention (diagrammatically shown in phantom at 12 in FIGS. 1 and 2) enables proper installation and secure, reliable mounting of the newel posts (5), thereby reinforcing the strength and stability of the balustrade (1). Further, the invention (12) may be completely concealed behind the stairway wall (7) (FIG. 1) or ceiling wall (14) (FIG. 2), thus ensuring that the staircase remains esthetically pleasing.

In one embodiment, the invention comprises a bracket for constructing a balustrade comprising: a receiving member configured to receive and secure a post therein; and a pivoting member pivotally mounted to the receiving member and configured to be attached to a top plate of a stairway wall to orient the post within the top plate at a desired position, angle, or both.

In one embodiment, the invention comprises a method of stabilizing a balustrade comprising the steps of forming a gap within the top plate for installing the bracket; sliding the bracket into position within the gap; fastening the bracket onto the top plate; preparing the post to fit into the bracket; inserting and attaching the prepared post within the bracket at a desired position, angle, or both.

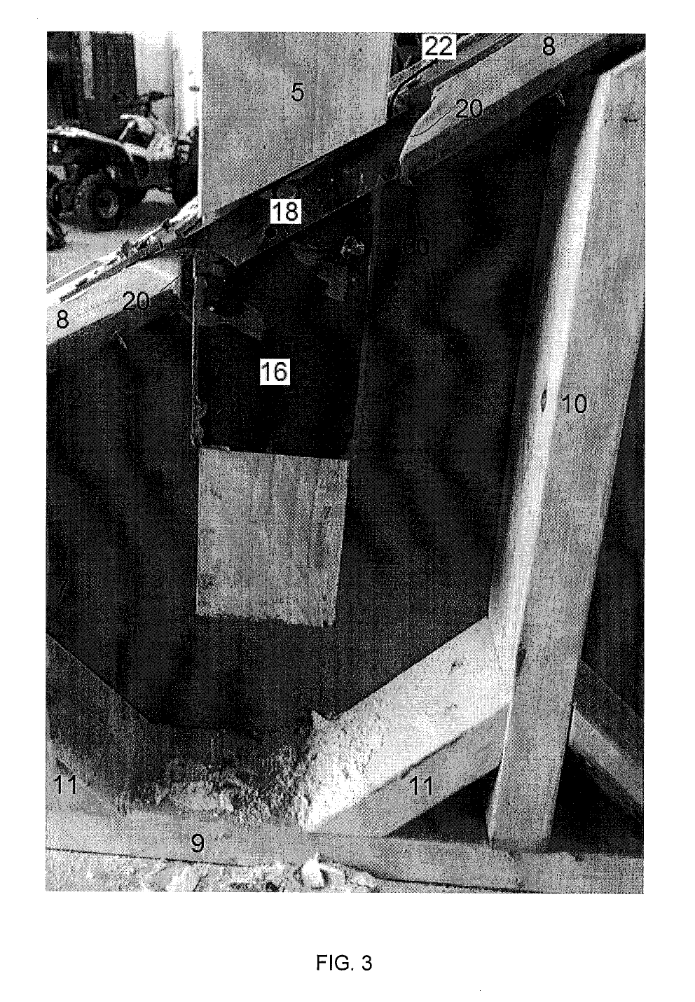

FIG. 3 generally shows one embodiment of the bracket (12) of the present invention in use in construction of a typical balustrade (1). One side of the wall (7) has been removed to display the bracket (12) and post (5) following installation. The bracket (12) comprises a receiving member (16) and a pivoting member (18). The receiving member (16) is configured to allow the insertion of the post (5). The pivoting member (18) is pivotally mounted to the receiving member (16) and is configured to be attached onto ends (20) of the top plate (8) of the wall (7), thereby suspending the receiving member (16) between the ends (20) of the top plate (8). The receiving member (16) and pivoting member (18) substantially align together in a manner to form and share an opening (22) extending therethrough for receiving the post (5).

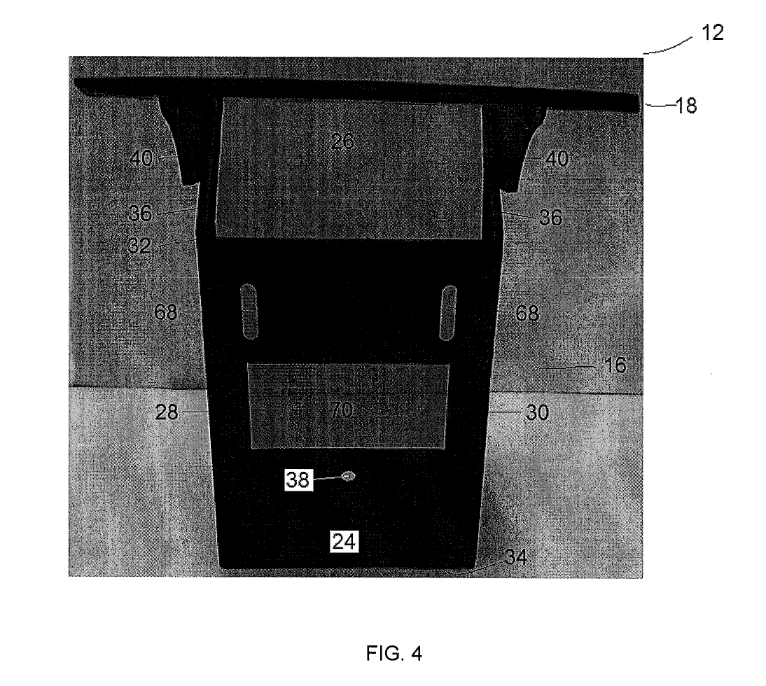

FIGS. 4-14E show embodiments of the bracket (12) removed from within the wall (7). The receiving member (16) comprises upstanding walls (24, 26, 28, 30) which project upwardly and define the opening (22). In one embodiment, the receiving member (16) comprises a front wall (24), a rear wall (26), a first side wall (28), a second side wall (30), an open first end (32) and an open second end (34). The front wall (24) opposes the rear wall (26). The first side wall (28) opposes the second side wall (30). At one edge, the front and rear walls (24, 26) merge with the first side wall (28). At the other edge, the front and rear walls (24, 26) merge with the second side wall (30). The open first and second ends (32, 34) together facilitate insertion of the post (5) through the opening (22).

In one embodiment, the front wall (24) is sized to be lower vertically than the rear wall (26), first side wall (28), and second side wall (30), as shown for example in FIG. 4.

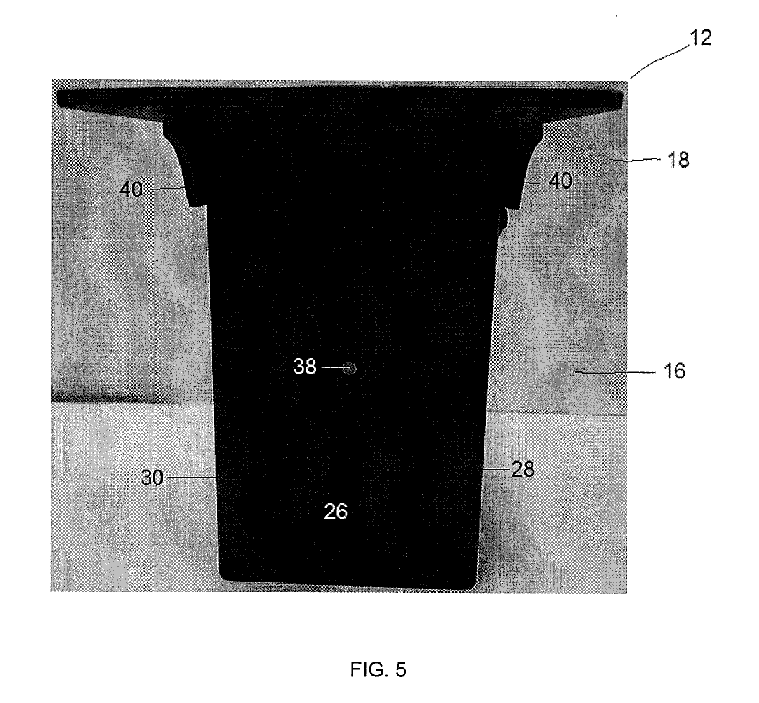

The rear wall (26) is connected to the side walls (28, 30) (FIG. 5). The rear wall (26) is sized to be higher vertically than the front wall (24), as shown for example in FIG. 4.

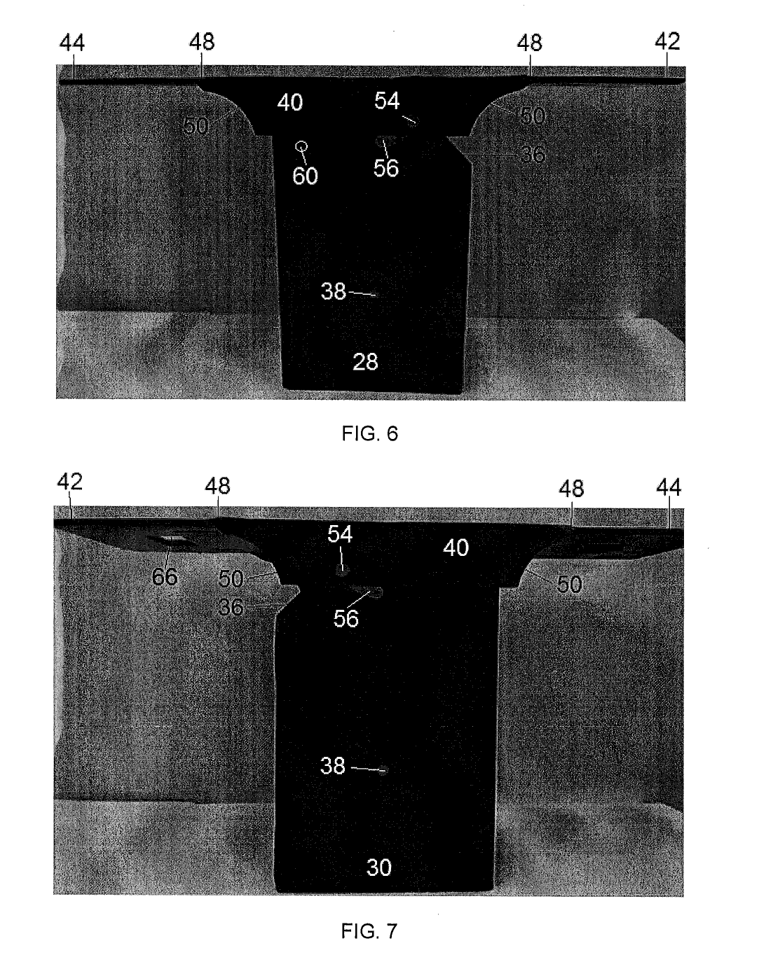

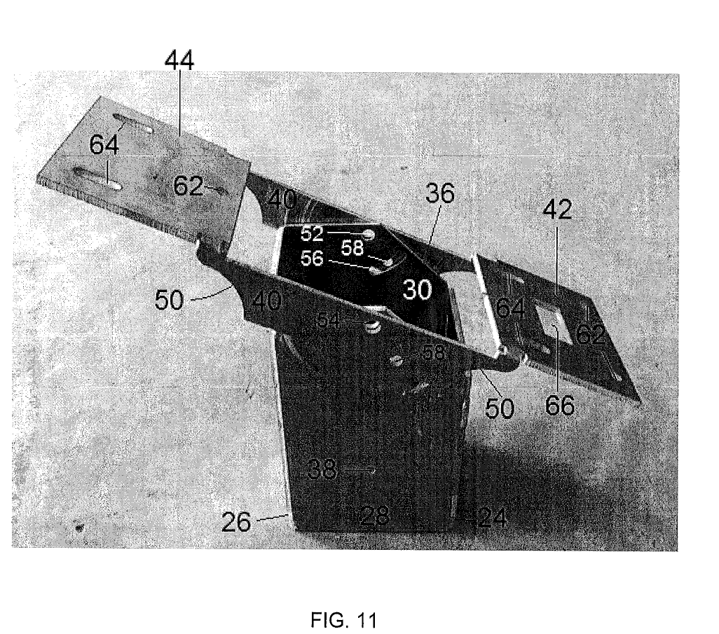

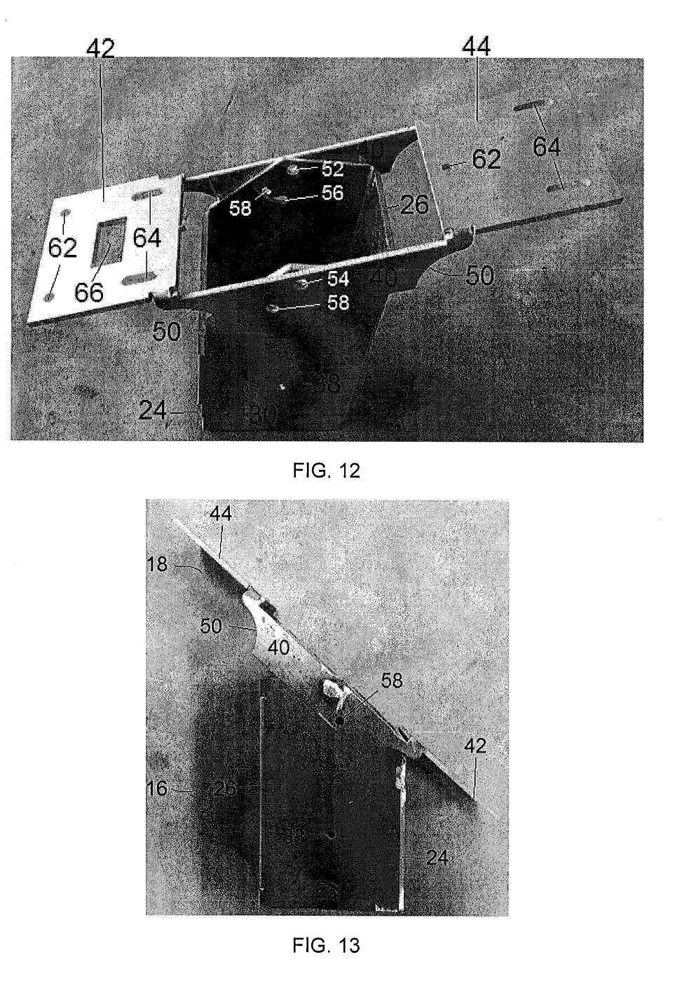

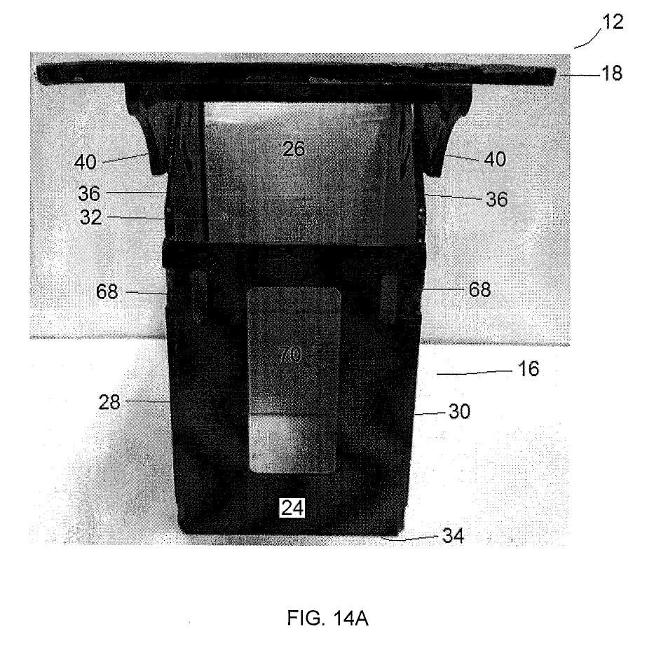

The first and second side walls (28, 30) are configured to be substantially identical to each other, as best shown when the bracket (12) is viewed from the side (FIGS. 6, 7, 11 and 12). The first and second side walls (28, 30) connect the front wall (24) to the rear wall (26). The first and second side walls (28, 30) are sized to be the same height vertically as the rear wall (26), but are cut away at the top corners (36) facing the front wall (24) (FIGS. 11-12). The top cut-away corners (36) are generally complementary to the vertical height of the front wall (24). The corners (36) are cut away to allow the pivoting member (18) to rotate easily and freely without protruding corners hindering its movement. In one embodiment, the cut-away corners (36) allow the pivoting member (18) to rotate to an angle of about 45° relative to the receiving member (16) (FIG. 13).

One or more of the front wall (24), rear wall (26), and side walls (28, 30) may define one or more apertures (38) through which attachment means may be inserted to secure the post (5) to the receiving member (16) (FIGS. 4-7 and 9-13). Suitable attachment means include, but are not limited to, screws, pins, rivets, bolts, and other types of fasteners. It is contemplated that the number (density), size (diameter), shape, and positioning of the apertures (38) for an embodiment of the bracket (12) may vary. Apertures (38) may be made using a number of methods known to those skilled in the art, including but not limited to drilling.

The shape of the receiving member (16) is not limited to that of the present example, but may variously be changed, for example, into a square, parallelogram, or the like. In one embodiment, the receiving member (16) of the bracket (12) may be substantially rectangular-shaped comprising planar front, rear and side walls (24, 26, 28, 30).

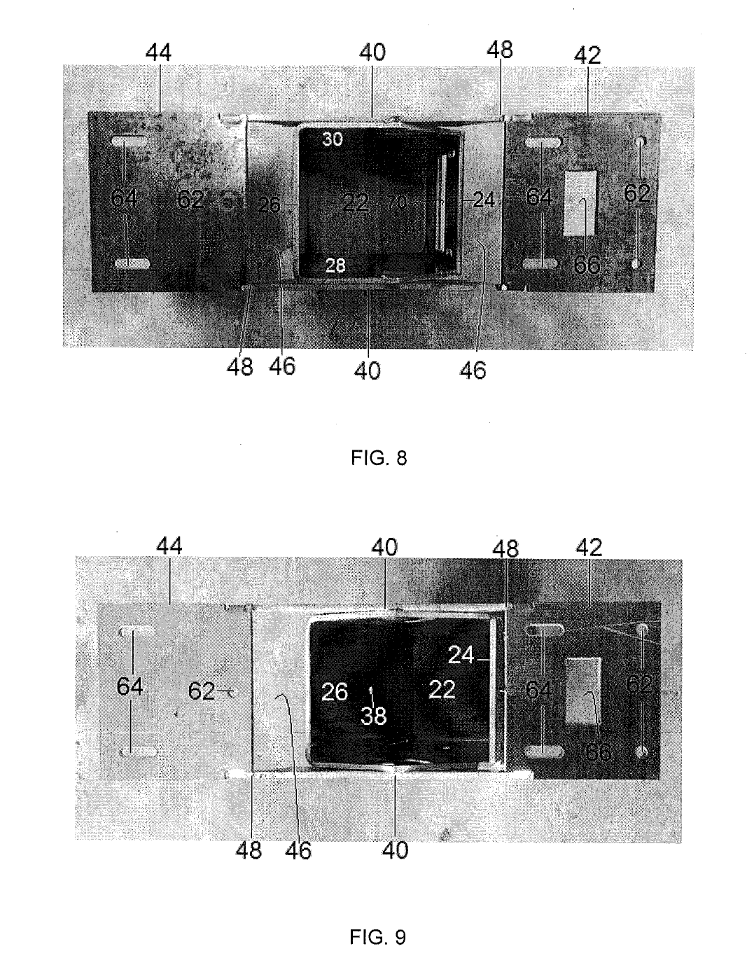

The pivoting member (18) comprises a pair of arms (40), a first mounting plate (42), a second mounting plate (44), and a gap (46) (FIGS. 8-9). The arms (40) are configured to be substantially identical to each other, as best shown when the bracket (12) is viewed from the top (FIGS. 8-9) or the side (FIGS. 11-12), The arms (40) are oriented opposed and parallel to each other, as best shown when the bracket (12) is viewed from the top (FIGS. 8-9). The arms (40) are connected at their ends (48) to the first and second mounting plates (42, 44). In one embodiment, each arm (40) is oriented perpendicularly to the first and second mounting plates (42, 44) (FIGS. 6, 7, and 11-13). The arms (40) and mounting plates (42, 44) together define the gap (46) (FIGS. 8-9). The gap (46) extends past the front wall (24) and the rear wall (26). The gap (46) defined by the arms (40) and mounting plates (42, 44) is sized to receive and accommodate the receiving member (16). In one embodiment, the gap (46) is sized to extend past the front wall (24) and rear wall (26) of the receiving member (16). The dimensions of the gap (46) are thus dictated by the size of the receiving member (16).

In one embodiment, each arm (40) is substantially rectangular-shaped with a bottom cut-away corner (50) at each end (48) (FIGS. 6, 7 and 11-13). The cut-away corners (50) substantially conform to the ends (20) of the top plate (8) to facilitate the installation of the bracket (12) (FIG. 3). The shape of the cut-away corners (50) is not limited to that of the present example, but may variously be changed, for example, straight or curved. In one embodiment, the cut-away corners (50) are curved. During installation of the bracket (12), the curved cut-away corners (50) minimize the amount of preparation required for the ends (20) of the top plate (8) and facilitate insertion of the post (5).

The arm (40) protrudes past the edges of the side wall (28, 30) to allow the pivoting member (18) to be mounted over the receiving member (16). In one embodiment, the arm (40) has a length greater than the width of the side wall (28, 30) (FIG. 8).

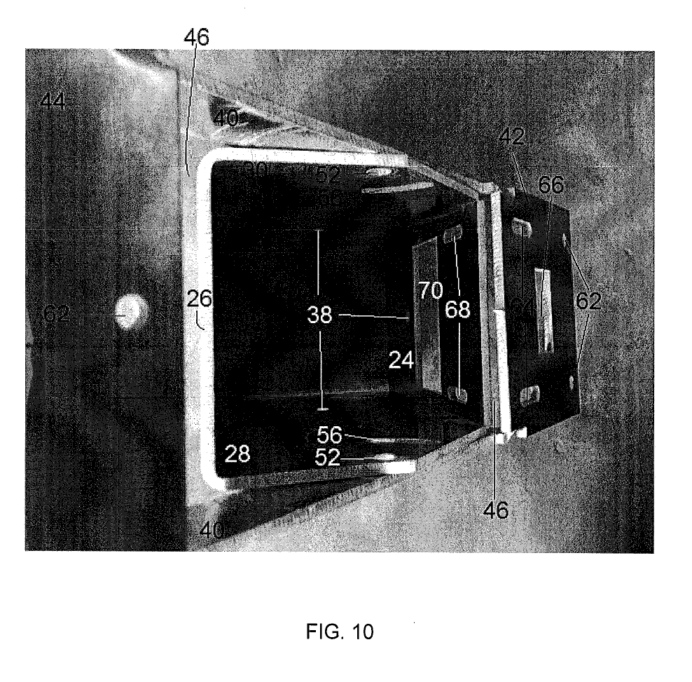

The first and second side walls (28, 30) define opposed bores (52) positioned at the top of the side walls (28, 30) and adjacent to the top cut-away corners (36) (FIG. 10). The arms (40) define opposed throughholes (54) which align with the corresponding bores (52) of the side walls (28, 30) to allow attachment means to extend therethrough to pivotally mount the pivoting member (18) to the receiving member (16) (FIGS. 11-12). In one embodiment, the throughholes (54) and bores (52) are positioned along the top edges of the arms (40) and side walls (28, 30) respectively, such that the pivoting member (18) is mounted to the receiving member (16) at the top edges of the side walls (28, 30). It is contemplated that the throughholes (54) and corresponding bores (52) may vary in position to allow the pivoting member (18) to be mounted in any desired position along the side walls (28, 30). Suitable attachment means include, but are not limited to, screws, pins, rivets, bolts, and other types of fasteners.

In addition, the first and second side walls (28, 30) define opposed curved slots (56) positioned below the bores (52) (FIGS. 10-12). The slots (56) curve in a pathway from beneath the bores (52) upward toward the top cut-away corners (36). The arms (40) define opposed openings (58) which are positioned at the bottom edge of the arms (40), and at an angle beneath the throughholes (54) (FIGS. 11-12). The openings (58) align with and follow the pathway of the curved slots (56) as the pivoting member (18) is moved from a resting position wherein the pivoting member (18) is not tilted, to an actuating position wherein the pivoting member (18) is tilted in the direction of the front wall (24). During use, attachment means are inserted through the openings (58) of the arms (40) and the curved slots (56) of the side walls (28, 30) to position the bracket (12) at any desired position, angle, or both. Suitable attachment means include, but are not limited to, screws, pins, rivets, bolts, and other types of fasteners.

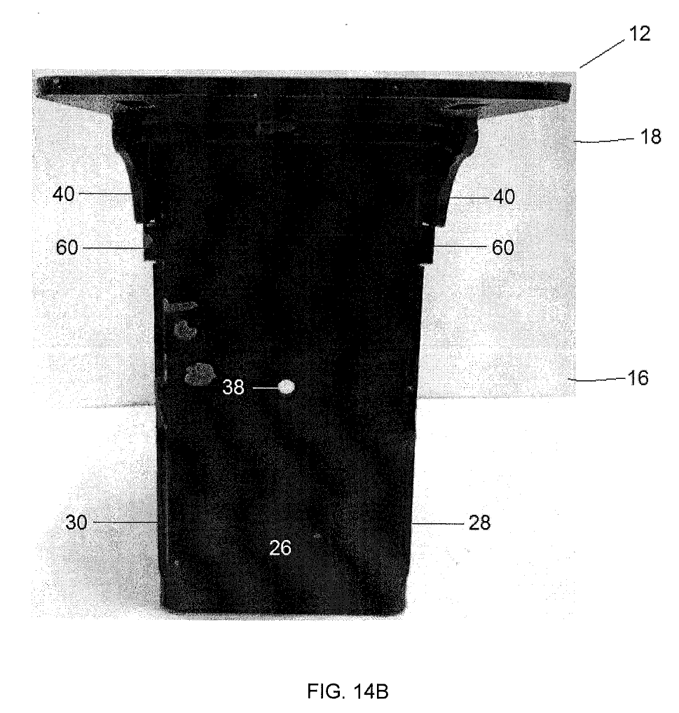

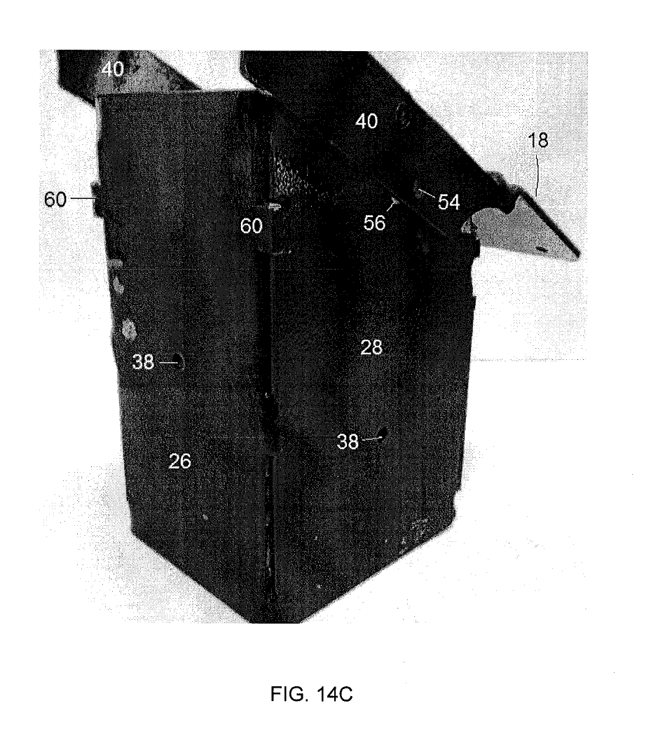

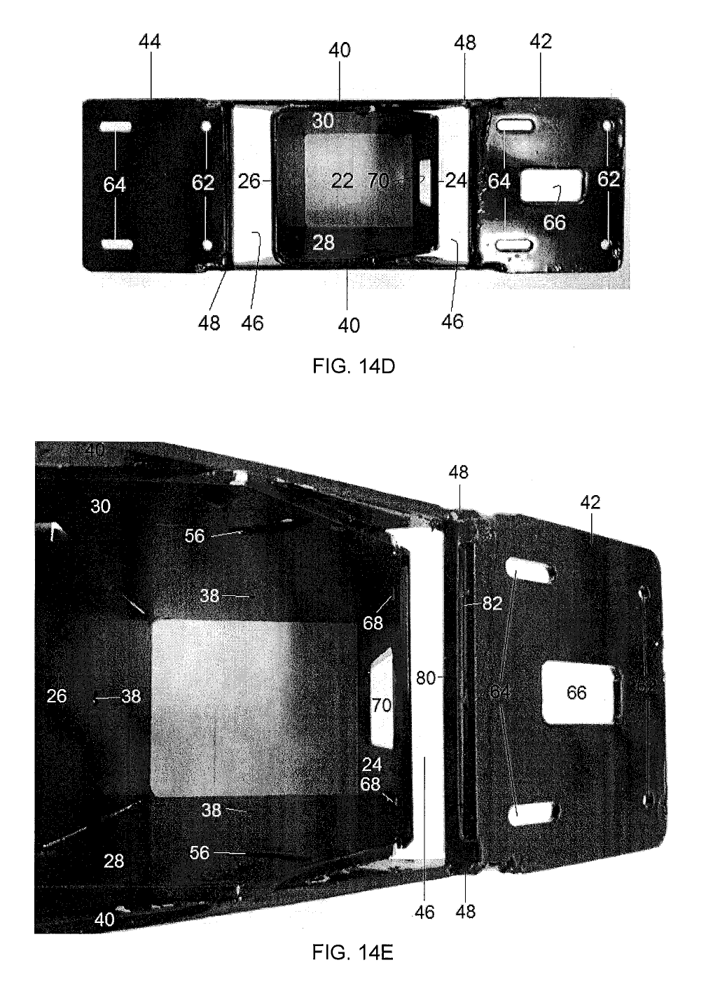

A stopper or protuberance (60) is disposed on the outer surface of one of the side walls (28, 30) or defined by the rear will (26), and projects outwardly with respect to the side wall (28, 30) or rear wall (26) (FIGS. 3, 6 and 14B-C). In one embodiment, the stopper (60) may comprise a rivet or a portion of cold rolled steel which is fixed to the side wall (28) by welding or other techniques known to those skilled in the art (FIGS. 3 and 6). In one embodiment, the stopper (60) may comprise a tab defined by the rear wall (26) (FIGS. 14B-C). The stopper (60) restrains the movement of the pivoting member (18) by protruding outwardly to abut the arm (40) of the pivoting member (18), thereby preventing the pivoting member (18) from tilting in the direction of the rear wall (26). In one embodiment, the stopper (60) restrains the pivoting member (18) substantially “flat” or horizontal relative to the receiving member (16). In one embodiment, the pivoting member (18) is positioned at an angle of about 90° relative to the receiving member (16) (FIGS. 4-7).

The first and second mounting plates (42, 44) are substantially rectangular-shaped. However, the shape of the first and second mounting plates (42, 44) is not limited to that of the present example, but may variously be changed, for example, into a square or the like.

In one embodiment, the first and second mounting plates (42, 44) define one or more apertures (62) and/or one or more elongate slots (64) through which attachment means may be inserted to secure the bracket (12) onto the top plate (8) (FIGS. 8-12). Suitable attachment means include, but are not limited to, screws, pins, rivets, bolts, and other types of fasteners. It is contemplated that the number (density), size (diameter), shape, and positioning of the apertures (62) and slots (64) for an embodiment of the bracket (12) may vary. Apertures (62) and slots (64) may be made using a number of methods known to those skilled in the art, including but not limited to drilling and machining.

In one embodiment, the first mounting plate (42) is configured differently from the second mounting plate (44). In one embodiment, the first mounting plate (42) defines a pair of apertures (62), a pair of elongate slots (64), and a window (66). The apertures (62) and slots (64) are positioned at the corners of the first mounting plate (42), with the slots (64) being positioned at the edge of the first mounting plate (42) adjacent to the arms (40). The apertures (62) receive attachment means to secure the bracket (12) onto the top plate (8). The front wall (24) defines corresponding front wall slots (68) (FIGS. 4 and 10). The first mounting plate slots (64) facilitate the insertion of attachment means at an angle to extend through the first mounting plate (42), top plate (8), front wall slots (68), and post (5).

The window (66) is positioned near or at the center of the first mounting plate (42). The front wall (24) defines a corresponding window (70) (FIGS. 4, 10, and 14A). The windows (66, 70) are sized to receive a leg bolt or heavy screw. The leg bolt is drilled through the top plate (8) in a manner such that the leg bolt extends through the window (66) of the first mounting plate (42), the top plate (8), the window (70) of the front wall (24), and into the post (5) in order to secure the post (5) at the desired angle or position. The shape of the windows (66, 70) is not limited to that of the present example, but may variously be changed, for example, into a square, parallelogram, circular or the like. In one embodiment, the windows (66, 70) may be substantially rectangular-shaped. In one embodiment, the window (70) of the front wall (24) is larger than the window (66) of the first mounting plate (42) to facilitate positioning of the leg bolt at various angles more easily.

In one embodiment, the second mounting plate (44) defines an aperture (62) positioned centrally at the edge of the plate (44) adjacent to the arms (40), and elongate slots (64) positioned at the corners of the plate (44). In one embodiment, the second mounting plate (44) defines a pair of apertures (62) positioned at the corners of the second mounting plate (44) (FIG. 14D). The aperture(s) (62) receive(s) attachment means to secure the bracket (12) onto the top plate (8). The slots (64) facilitate the insertion of attachment means at an angle through the mounting plate (44) and top plate (8).

The pivoting member (18) may be pivoted relative to the receiving member (16), but any pivotal adjustment possible in the pivoting member (18) is limited by the receiving member (16) and stopper (60). The inclination or pitch angle of the pivoting member (18) is adjustable within the physical constraints of the receiving member (16), but no side-to-side rotation, commonly referred to as the yaw angle, is possible. In one embodiment, the inclination ranges from between about 45° to about 90°. The pivoting member (18) is pivotally mounted to the receiving member (16) to enable two positions of movement, namely a resting position and an actuating position.

In the resting position, the pivoting member (18) is resting substantially “flat” or horizontal relative to the receiving member (16). In one embodiment, the stopper (60) prevents the pivoting member (18) from tilting in the direction of the rear wall (26) such that the pivoting member (18) is positioned at an angle of about 90° relative to the receiving member (16) (FIGS. 6-8).

The pivoting member (18) is movable from the resting position wherein the pivoting member (18) is not tilted, to the actuating position wherein the pivoting member (18) is tilted in the direction of the front wall (24) during use (FIGS. 3 and 11-13). The top cut-away corners (36) of the first and second side walls (28, 30), and the lower vertical height of the front wall (24) compared to the rear and side walls (26, 28, 30) thereby allow the pivoting member (18) to rotate easily and freely without protruding corners or walls hindering its movement. As shown in FIG. 3, the pivoting member (18) is thus pivoted at an angle relative to the receiving member (16) to align with the ends (20) of the top plate (8) to hold the post (5) in the desired position, thereby stabilizing the balustrade (1). In one embodiment, the pivoting member (18) is positioned between an angle of about 45° to about 90° relative to the receiving member (16).

The dimensions are not essential to the invention and are dictated by the dimensions of the post (5). The dimensions of the bracket (12) may be increased or decreased as may be required to satisfy any particular design objectives; for example, the bracket (12) may be available in a variety of dimensions. In one embodiment, the bracket (12) has a height of about 6 inches, and a width of about eleven inches. In one embodiment, the receiving member (16) has a height of about six inches, and a width of about 3.5 inches. In one embodiment, the pivoting member (18) has a height of about one inch, and a width of about eleven inches.

The bracket (12) can be constructed from any material or combination of materials having suitable properties such as, for example, mechanical strength and ease of welding. Suitable materials include, but are not limited to, aluminum, steel, stainless steel, or other appropriate metals. Aluminum is preferable since it does not rust or corrode, and is softer and cheaper than steel, hence easier and inexpensive for manufacturing the bracket (12) (FIGS. 8-13). If steel is used for its construction, the bracket (12) is coated with a rust-inhibiting primer (FIGS. 4-7).

The receiving member (16) may be formed as a single, integral unit or “box” combining the front wall (24), rear wall (26), and side walls (28, 30), with the side walls (28, 30) being machined to form the cut-away corners (36). Alternatively, the walls (24, 26, 28, 30) may be formed independently and welded together to form a single, integral unit. In one embodiment, a single piece is bent to form the rear (26) and side walls (28, 30), with the finished front wall (24) (i.e., including any apertures (38, slots (68) and window (70)) then being welded to the side walls (28, 30). To facilitate the bending of the single piece, slots may be cut through the piece to define the rear (26) and side walls (28, 30) and/or to form the stopper (60) in the shape of a tab defined by the rear wall (26) (FIGS. 14B-C).

The pivoting member (18) may be formed as a single, integral unit combining the arms (40) and mounting plates (42, 44) in a planar form or flat sheet, with the arms (40) then being folded or bent over. A portion (80) of each mounting plate (42, 44) may be folded or bent over by cutting a notch (82) to add strength between the ends (48) of the arms (40) and the mounting plate (42, 44) (FIG. 14E). Alternatively, the arms (40) and mounting plates (42, 44) are manufactured separately as components which are welded together. Any apertures (38, 62), bores (52), throughholes (54), openings (58), slots (56, 64), and windows (66, 70) may be made in the appropriate components using any hole- or window-making operations known to those skilled in the art, including but not limited to drilling, reaming, tapping, boring, machining, and the like.

In general, the bracket (12) requires few components, making the bracket (12) amenable to rapid assembly and minimizing expense in manufacturing. Alternatively, the bracket (12) may be formed using waterjet cutting which involves use of a water jet cutter to fabricate the components of the bracket (12).

The installation of the bracket (12) can be performed easily by building contractors, construction companies, and home builders. The bracket (12) enables the positioning and placing of the posts (5), negating the need to rely upon studs and floor joists. The bracket (12) can be used to secure the post (5) in any desired location and/or angle within the wall (7).

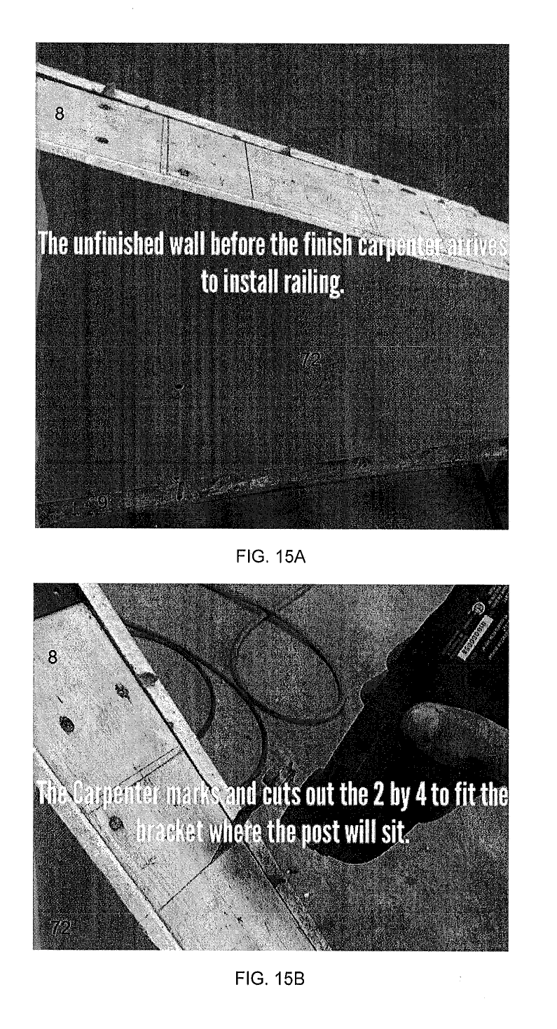

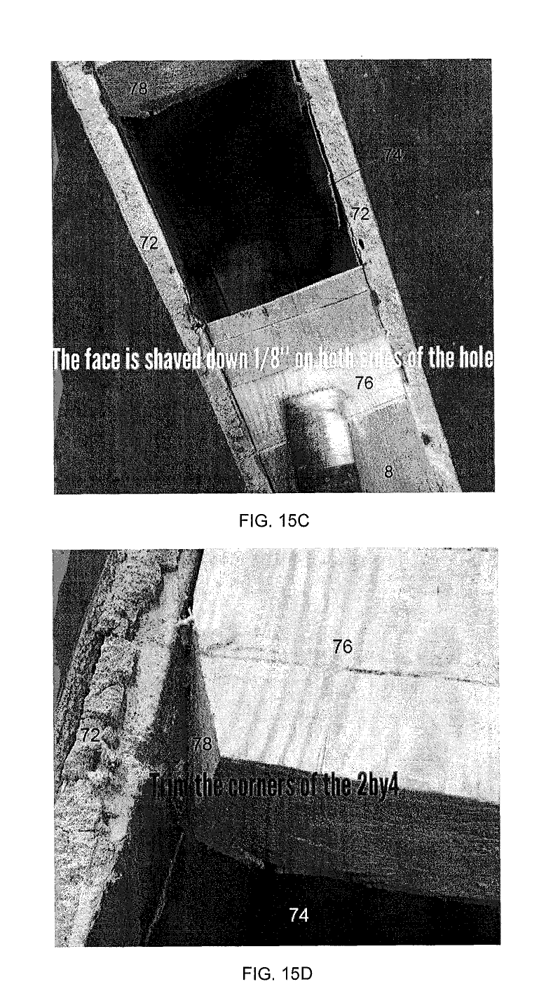

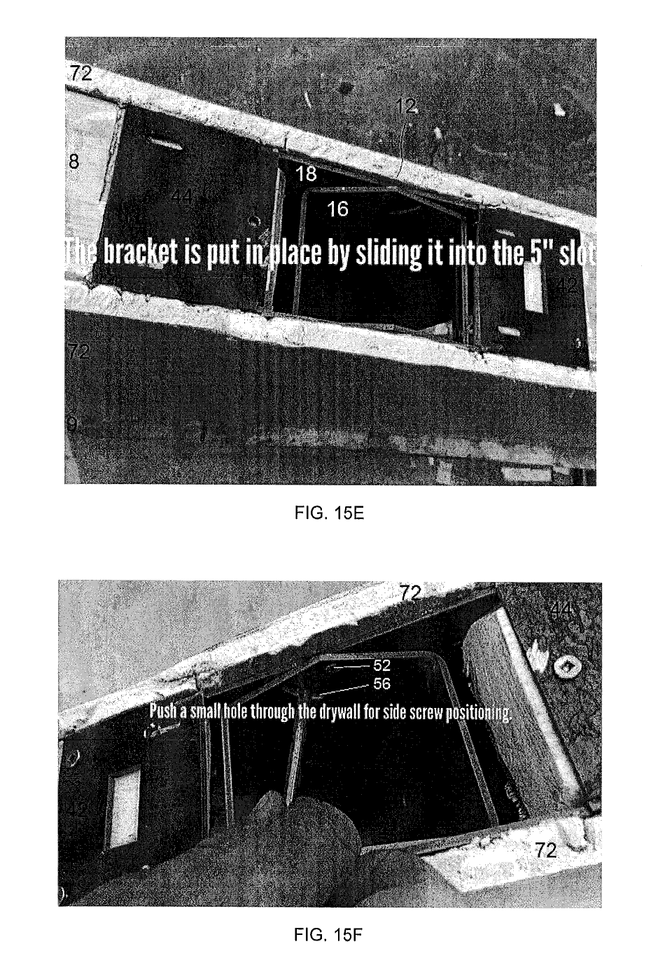

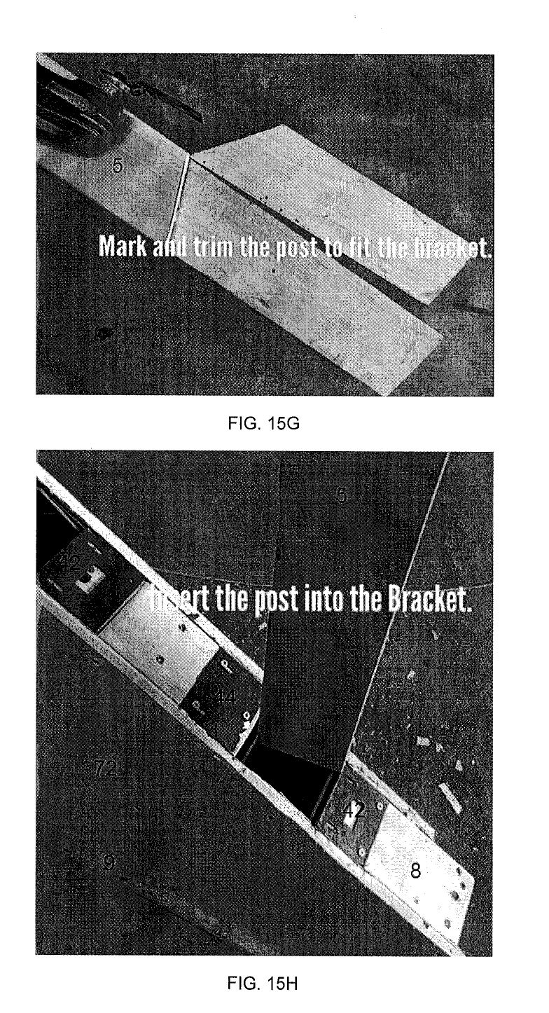

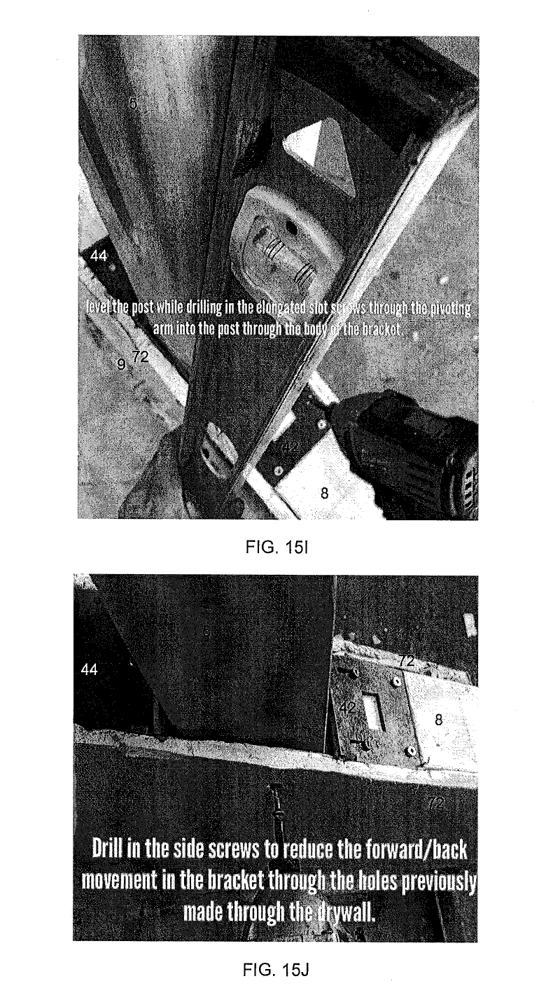

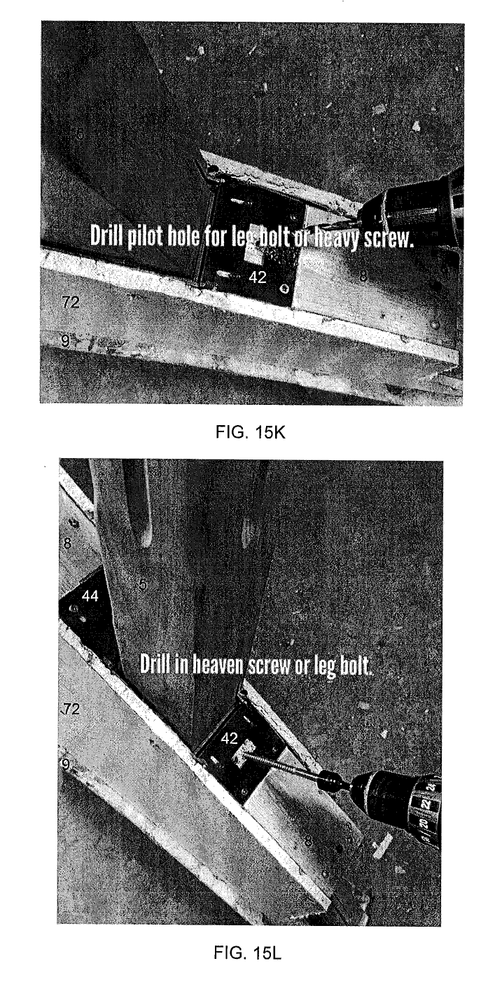

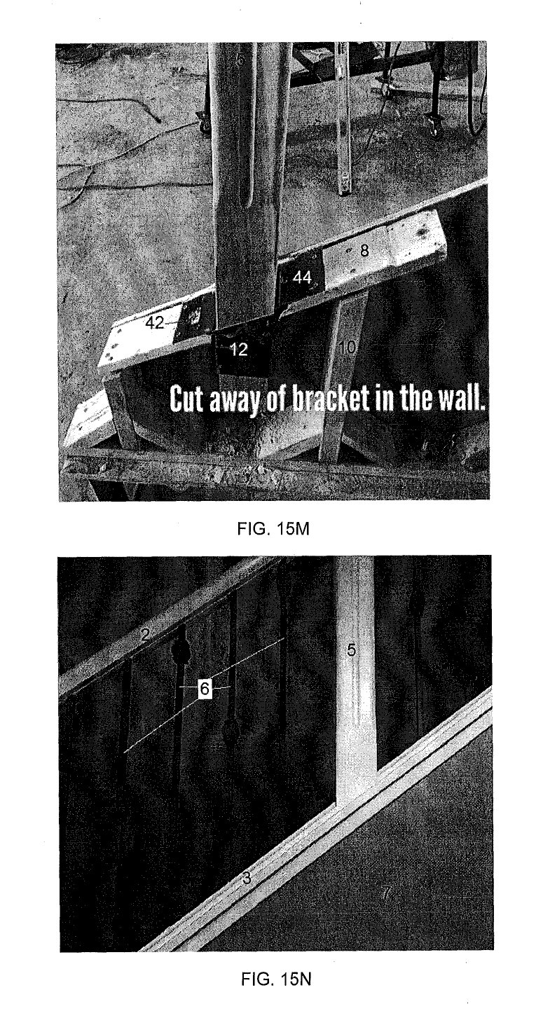

In operation, the bracket (12) is installed within a stairway wall (7) formed of a top plate (8), a base plate (9), and sides (72). The top plate (8) typically comprises dimensional lumbar such as, for example, a two-by-four board. The top plate (8) is first prepared by measuring and marking a section to accommodate the bracket (12) where the post (5) is to be positioned (FIG. 15A). The section is cut away, thereby leaving a gap (74) into which the bracket (12) can be installed (FIGS. 15B-C). In one embodiment, the gap (74) has a width of about 5″. The faces of the top plate (8) which line the gap (74) are shaved down to form notches (76). In one embodiment, the faces are shaved down by about ⅛″ (FIG. 15C). The notches (76) are complementary to the shapes of the first and second mounting plates (42, 44) to seat the mounting plates (42, 44). The corners of the top plate (8) are trimmed to form angled edges (78) which are complementary to the cut-away corners (50) of the arms (40) (FIG. 15D).

The bracket (12) is slid into position within the gap (74) (FIG. 15E). Attachment means are inserted through the apertures (62) of the first and second mounting plates (42, 44) to secure the plates (42, 44) within the notches (76) formed in the top plate (8) (FIG. 15F). A pilot hole is bored through each side (72) of the wall (7) by pushing a screw through the elongate slot (56) of each side wall (28, 30) and the opening (54) of each arm (40).

The post (5) is sized or trimmed to fit within the receiving member (16) of the bracket (12), and is cut to the desired length (FIG. 15G). The post (5) is inserted into the receiving member (16) of the bracket (12) (FIG. 15H). FIG. 15H also shows an additional bracket (12) since the top plate (8) may include more than one bracket (12) for use with multiple posts (5). Posts (5) may be secured substantially horizontal or at any degree of angle (for example, up to 45°) within the wall (7). The post (5) is secured at the desired height into the receiving member (16) using attachment means such as screws. The post (5) is levelled while screws are drilled through the elongated slots (64) of the first mounting plate (42) into the post (5) (FIG. 15I). Using the pilot holes, screws are drilled into the desired position through the sides (72) of the wall (7), thereby reducing any forward or backward movement of the post (5) and securing the post (5) within the receiving member (16) (FIG. 15J).

The leg bolt or heavy screw can be used to facilitate anchoring the post (5) at the desired angle, position, or both. A pilot hole for either the leg bolt or the heavy screw is drilled through the window (66) of the first mounting plate (42), the top plate (8), the window (70) of the front wall (24), and the post (5) (FIG. 15K). The leg bolt or heavy screw is then drilled through the pilot hole to extend through the window (66) of the first mounting plate (42), top plate (8), window (70) of the front wall (24), and into the post (5) (FIG. 15L).

The balustrade (1) is then completed in a manner well known to those skilled in the art (FIG. 15M-N). Embodiments of the bracket (12) in use are shown for example, in FIGS. 1-2. The present invention (diagrammatically shown in phantom at 12 in FIGS. 1 and 2) enables proper installation and secure, reliable mounting of the newel posts (5), thereby reinforcing the strength and stability of the balustrade (1). Further, the invention (12) may be completely concealed behind the stairway wall (7) (FIGS. 1 and 15N) or ceiling wall (14) (FIG. 2), thus ensuring that the staircase remains esthetically pleasing.

It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

### REFERENCES

All publications mentioned herein are incorporated herein by reference (where permitted) to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

Bobrowski, L. G. Guardrail assembly. U.S. Pat. No. 3,342,457, published Sep. 19, 1967.

Burt, K. T., Sherstad, M. C. and Irick, J. D. Bracket for supporting attachment of the end of a railing member to a vertical member. United States Patent Application Publication No. 2013/0175488 A1, published Jul. 11, 2013.

Dotsey, M. Rail assembly having a baluster swing bracket. U.S. Pat. No. 8,376,321, published Feb. 19, 2013.

Erwin, R. D. Rail-to-post mounting bracket. U.S. Pat. No. 6,471,192, published Oct. 29, 2002.

Erwin, R. D. Mounting bracket for railing. U.S. Pat. No. 6,527,469, published Mar. 4, 2003.

Erwin, R. D. Fence bracket. U.S. Pat. No. 6,557,831, published May 6, 2003.

Fletcher, R. J. and Williams, E. J. Fencing structures. UK Patent Application No. GB 2,005,325 A, published Apr. 19, 1979.

Ford, G. N. Arrangement and method for connecting fence sections. International Publication No. WO 2008/018964, published Feb. 14, 2008,

Fuoco, M. Temporary structure bracket. U.S. Pat. No. 7,377,491, published May 27, 2008.

Heinz, D. E. Fence angular connector assembly. U.S. Pat. No. 4,923,176, published May 8, 1990.

Hentzschel, W. G. Fence rail bracket. U.S. Pat. No. 5,186,571, Feb. 16, 1993.

Hocking, W. P. Anchoring device. U.S. Pat. No. 4,599,010, published Jul. 8, 1986.

Leone, N. Bracket for a fencing system. U.S. Pat. No. 5,961,242, published Oct. 5, 1999.

Milner, W., Diener, R. and Rose, D. Connection fixture. International Publication No. WO 2009/126989, published Oct. 22, 2009.

Newlin, F. Coupling. U.S. Pat. No. 1,070,165, published Aug. 12, 1913.

Otte, D. R. and Krueger, S. E. Railing construction. U.S. Pat. No. 4,919,394, published Apr. 24, 1990.

Platt, R. E. Unitary rail mounting bracket. United States Patent Application Publication No. 2007/0187662, published Aug. 16, 2007.

Schultz, D. H., Mattson, S. W. and Heinz, D. E. Railing construction, U.S. Pat. No. 4,951,925, published Aug. 28, 1990.

Sneith, J. M. Baluster bracket assembly, United States Patent Application Publication No. 2013/0214228, published Aug. 22, 2013.

What is claimed is:

1. A bracket for constructing a balustrade comprising:
a receiving member configured to receive and secure a post therein; and
a pivoting member pivotally mounted to the receiving member and configured to be attached to a top plate of a wall to orient the post within the top plate at a desired position, angle, or both.

2. The bracket of claim 1, wherein the receiving member and pivoting member are substantially aligned to define an opening extending therethrough for receiving the post.

3. The bracket of claim 2, wherein the receiving member comprises a front wall, a rear wall, a first side wall, a second side wall, an open first end, and an open second end.

4. The bracket of claim 3, wherein the front wall is sized lower vertically than the rear wall, the first side wall, and the second side wall.

5. The bracket of claim 4, wherein the first side wall and the second side wall are sized the same height vertically as the rear wall, and have top cut-away corners complementary to the vertical height of the front wall.

6. The bracket of claim 5, wherein one or more of the front wall, rear wall, first side wall, and second side wall define one or more apertures to allow attachment means to extend therethrough to secure the post to the receiving member.

7. The bracket of claim 1, wherein the pivoting member comprises a pair of arms, a first mounting plate, and a second mounting plate, wherein the arms, the first mounting plate, and the second mounting plate define a gap sized to receive and accommodate the receiving member.

8. The bracket of claim 7, wherein the gap extends past the front wall and the rear wall.

9. The bracket of claim 7, wherein the arms are oriented opposed and parallel to each other, are connected at their ends to the first and second mounting plates, and have a bottom cut-away corner at each end.

10. The bracket of claim 9, wherein the arms protrude past the edges of the first and second side walls.

11. The bracket of claim 10, wherein the arms define opposed throughholes which align with corresponding bores of the first and second side walls to allow attachment means to extend therethrough to pivotally mount the pivoting member to the receiving member.

12. The bracket of claim 11, wherein the throughholes and the bores are positioned along top edges of the first and second side walls.

13. The bracket of claim 12, wherein the first and second side walls define opposed curved slots positioned below the bores.

14. The bracket of claim 13, wherein the arms define opposed openings positioned at the bottom edge of the arms.

15. The bracket of claim 3, wherein a stopper projects outwardly from either the first side wall, the second side wall, or the rear wall.

16. The bracket of claim 7, wherein the first and second mounting plates define one or more apertures, one or more elongate slots, or both to allow attachment means to extend therethrough to secure the first and second mounting plates onto the top plate.

17. The bracket of claim 16, wherein the front wall defines one or more slots corresponding to the one or more elongate slots of the first mounting plate.

18. The bracket of claim 17, wherein the first mounting plate defines a window, and the front wall defines a window corresponding to the first mounting plate window, the windows being sized to receive a leg bolt therethrough.

19. The bracket of claim 7, wherein the pivoting member is pivotable between an angle of about 45° to about 90° relative to the receiving member.

20. A method of stabilizing a balustrade comprising the steps of:
a) forming a gap within the top plate of the wall for installing the bracket of claim 1;
b) sliding the bracket into position within the gap;
c) fastening the bracket onto the top plate;
d) preparing the post to fit into the bracket; and
e) inserting and attaching the post within the bracket at a desired position, angle, or both.

21. The method of claim 20, further comprising forming notches on the top plate, the notches being complementary to first and second mounting plates of the pivoting member, and fastening the first and second mounting plates to the notches.

22. The method of claim 21, further comprising forming angled edges within the top plate, the edges being complementary to cut-away corners of arms of the pivoting member.

23. The method of claim 22, further comprising drilling a leg bolt through the top plate to extend through a mounting plate window, the top plate, a front wall window, and the post.

24. The method of claim 23, wherein the pivoting member is pivoted between an angle of about 45° to about 90° relative to the receiving member.
